(19) United States
(12) Patent Application Publication
(10) Pub. No.: US 2005/0042519 A1
(43) Pub. Date: Feb. 24, 2005

(54) Electrolyte composition, lithium battery using the same, and method of manufacturing the lithium battery

(75) Inventors: Kwon Sun Roh, Cheonan-city (KR); Jong Hyuk Choi, Seoul (KR); Chi Kyun Park, Montville, NJ (US); Jon Ha Lee, Daejeon-city (KR)

Correspondence Address: NIXON & VANDERHYE, PC, 1100 N GLEBE ROAD, 8TH FLOOR, ARLINGTON, VA, 22201-4714, US

(73) Assignee: SKC CO., LTD., Suwon-ciy (KR)

(21) Appl. No.: 10/920,162

(22) Filed: Aug. 18, 2004

(30) Foreign Application Priority Data
Aug. 19, 2003 (KR) 2003-57276

(51) Int. Cl. H01M 10/40; H01M 10/04

(52) U.S. Cl. 429/330; 429/326; 429/314; 29/623.2

(57) ABSTRACT

An electrolyte composition, a lithium battery using the electrolyte composition, and a method of manufacturing the lithium battery are provided. The electrolyte composition includes: a lithium salt, and an organic solvent containing a nitrogen-containing compound, propane sultone, and vinylene carbonate and/or cyclohexylbenzene. The electrolyte composition ensures a battery safety when operated at high temperature without performance degradation.

### BACKGROUND OF THE INVENTION

This application claims the priority of Korean Patent Application No. 2003-57276, filed on Aug. 19, 2003, in the Korean Intellectual Property Office, the disclosure of which is incorporated herein in its entirety by reference.

1. Field of the Invention

The present invention relates to an electrolyte composition, a lithium battery using the same, and a method of manufacturing the lithium battery, and more particularly, to an electrolyte composition with improved safety when operated at high temperature, which is prepared by dissolving a particular additive composition in an organic electrolyte, a lithium battery using the electrolyte composition, and a method of manufacturing the lithium battery.

2. Description of the Related Art

As an increasing number of electronic devices, especially, portable devices such as personal digital assistants (PDAs), mobile phones, notebook computers, etc. spreads widely and become used in more application fields, there has been intensive research on batteries as driving sources for such devices with the need for smaller, thin design, lightweight, high-performance batteries.

Among various kinds of batteries lithium batteries have been used as typical driving power sources for portable devices due to the lightweight and high energy density thereof. A lithium battery consists of a cathode, an anode, a separator, and an electrolyte solution interposed between the cathode and the anode to provide a path of lithium ions. The lithium battery produces electrical energy by oxidation/reduction reactions occurring when the intercalation/deintercalation of lithium ions occurs at the cathode and the anode.

However, when a charged lithium battery is left at a high temperature above 150° C., the temperature of the battery rises due to the exothermic reaction between a charged anode active material and an electrolyte solution, thereby causing subsequent exothermic reactions leading to melting of the electrolyte solution and shorting of the separator or decomposition of the cathode active material. Eventually, thermal runaway phenomenon occurs, thereby raising safety concerns.

To solve this problem, there has been tried to suppress the overcharging of the lithium battery by changing the composition of the electrolyte solution or by adding an additive to the electrolyte composition. Japanese Patent Laid-open No. hei 10-50342 and No. 2000-3724 disclose lithium batteries with suppressed self-discharging characteristic and improved lifespan characteristics, capacity, and low-temperature characteristics by using propane sultone as an additive for electrolyte. Japanese Patent Laid-open No. 2001-30773 discloses a non-aqueous electrolytic battery that does not swell at a high temperature and has improved safety in the case of overcharging by containing lithium carbonate in a positive electrode and propane sultone in an aqueous electrolyte.

However, in Japanese Patent Laid-open No.10-50342 and No. 2000-372, any effect of the propane sultone used as an additive on the safety when operated at high temperature is not disclosed. The composition disclosed in Japanese Patent Laid-open No. 2001-307773 improves high-temperature stability but deteriorates battery performance.

### SUMMARY OF THE INVENTION

The present invention provides an electrolyte composition with improved safety when operated at high temperature.

The present invention provides a lithium battery using the electrolyte composition.

The present invention provides a method of manufacturing the lithium battery.

According to an aspect of the present invention, there is provided an electrolyte composition comprising: a lithium salt; and an organic solvent containing a nitrogen-containing compound, propane sultone, and vinylene carbonate and/or cyclohexylbenzene.

According to another aspect of the present invention, there is provided a lithium battery containing the electrolyte composition.

According to another aspect of the present invention, there is provided a lithium battery, the method comprising: injecting the electrolyte composition into a battery container in which an anode, a cathode, and a separator are contained; and sealing the battery container.

### DETAILED DESCRIPTION OF THE INVENTION

The present invention will be described in detail.

Conventionally, propane sultone has been used as an additive for electrolyte solution so as to improve battery lifespan and prevent self-discharging and high-temperature swelling. However, in the present invention propane sultone is used as an additive for electrolyte solution so as to ensure safety when operated at high temperature, and the improvement effect of the propane sultone is proved.

However, an electrolyte composition containing propane sultone that has an effect on safety when operated at high temperature may deteriorate battery performance. To solve this problem, in a polymer electrolyte composition and a lithium battery using the polymer electrolyte according to the present invention, the amount of propane sultone is reduced and vinylene carbonate and/or cyclohexylbenzene are used as auxiliary additives to ensure safety when operated high temperature without deteriorating battery performance.

A polymer electrolyte composition according to the present invention includes a lithium salt and an organic solvent containing additives for providing safety when operated at high temperature, i.e., a nitrogen-containing compound, propane sultone, and vinylene carbonate and/or cyclohexylbenzene. The amount of the nitrogen-containing compound may range from 0.1 to 5.0% by weight, the amount of propane sultone may range from 0.05-2.0% by weight, and the amount of vinylene carbonate and/or cyclohexylbenzene may range from 0.25 to 6.0% by weight, based on the total weight of the electrolyte composition. The amount of vinylene carbonate when used alone may range from 0.25-3% by weight.

The nitrogen-containing compound used in the present invention suppresses side reactions between the anode and electrolytic impurities, such as moisture and hydrofluoric acid (HF), at a high temperature (150° C. for 10 minutes) by effectively removing HF or a Lewis base from the electrolyte solution. Specific examples of the nitrogen-containing compound that can be used in the present invention include monomers such as a primary, secondary, or tertiary amine, and polymers, copolymers and oligomers of these amines, preferably, 6-member aromatic heterocyclic compound, and 5-member fused aromatic heterocyclic compound; and monomers such as aromatic or non-aromatic secondary or tertiary amines, and polymers, copolymers and oligomers thereof.

Preferred examples of the 6-member aromatic heterocyclic compound include pyridine, pyridazine, pyrimidine, pyrazine, and triazine. Preferred examples of the 5-member fused aromatic heterocyclic compound include triazole, thiazole, and thiadiazole. The aromatic or non-aromatic secondary and tertiary amine compounds may contain at least one nitrogen atom or at least five carbon atoms. If the amount of the nitrogen-containing compound is less than 0.1% by weight, the HF or Lewis base present in the electrolyte solution cannot be effectively captured. If the amount of the nitrogen-containing compound is greater than 5% by weight, the high-rate discharge characteristic of the battery deteriorates.

The propane sultone used in the present invention suppresses side reactions between the electrode and the electrolyte solution at a high temperature. The amount of the propane sultone may range from 0.05 to 2.0% by weight based on the total weight of the electrolyte composition. If the amount of the propane sultone is less than 0.05% by weight, the effect of suppressing the side reactions is trivial. If the amount of the propane sultone is greater than 2.0% by weight, battery performance deteriorates.

The vinylene carbonate and/or cyclohexylbenzene used in the present invention suppress side reactions between the anode or cathode and the electrolyte solution. The amount of the vinylene carbonate and/or cyclohexylbenzene may range from 0.25 to 6.0% by weight based on the total weight of the electrolyte composition. If the amount of the vinylene carbonate and/or cyclohexylbenzene is less than 0.25% by weight, the effect of suppressing the side reactions is trivial. If the amount of the vinylene carbonate and/or cyclohexylbenzene is greater than 6.0% by weight, the capacity and high-rate characteristic of the battery deteriorate. The amount of the vinylene carbonate when used alone may range from 0.25 to 3.0% by weight.

In addition to the nitrogen-containing compound, propane sultone, and vinylene carbonate and/or cyclohexylbenzene, the electrolyte composition according to the present invention may further include an epoxy-containing compound as an additive.

The epoxy-containing compound causes gelation of the electrolyte composition by the reaction with the nitrogen-containing compound at a high temperature. Therefore, the electrolyte composition according to the present invention can be converted into a gel polymer electrolyte by adding the epoxy-containing compound and heating the mixture. The electrolyte composition according to the present invention may contain 0.02-1.5% by weight of the epoxy-containing compound based on the total weight of the electrolyte composition.

Specific examples of the epoxy-containing compound include 3,4-epoxycyclohexylmethyl-3′,4′-epoxycyclohexane carboxylate, glycidyl dodecafluoroheptylether, butadienediepoxide, butandiol diglycidyl ether, cyclohexene oxide, cyclopentene oxide, diepoxy cyclooctane, ethylene glycol diglycidyl ether, and 2,3-epoxy hexane.

Any lithium salt and organic solvent that are commonly used in the field can be used for the lithium salt and the organic solvent in the electrolyte composition according to the present invention. Specific examples of the lithium salt that can be used in the present invention include LiPF₆, LiAsF₆, LiCIO₄, LiN(CF₃SO₂)₂, LiBF₄, LiCF₃SO₃, and LiSbF₆. Examples of the organic solvent that can be used in the present invention include ethylene carbonate (EC), diethylene carbonate (DEC), propylene carbonate (PC), dimethylene carbonate (DMC), ethylmethyl carbonate (EMC), γ-butyrolactone (GBL), and a mixture of these solvents. The amount of PC used for the organic solvent may be in a range of 15-50% by weight based on the total weight of the electrolyte composition.

The electrolyte composition according to the present invention may include 0.5-2M lithium salt in the organic solvent.

The electrolyte composition according to the present invention is prepared by dissolving the amount of the above-listed additives in an organic solvent containing a lithium salt. In addition, a lithium battery including a cathode, an anode, and a separator therebetween can be manufactured using the electrolyte composition. In particular, a stack of the cathode, the anode, and the separator is rolled into a jelly roll, placed in a battery container, and sealed. The electrolyte composition is injected into the container and heated at a temperature of 30-130° C. if required, i.e., when a halogen- or epoxy-containing compound is included, to soak and gelate the electrolyte composition, thereby resulting in a complete lithium battery.

In the present invention electrodes that are commonly used for lithium ion batteries can be used. A cathode composition used in the present invention may include 100 parts by weight of a cathode active material, such as LiCoO₂, 1-10 parts by weight of a conducting agent, such as carbon black, 2-10 parts by weight of a binder, such as polyvinylidene fluoride (PVDF), and 30-100 parts by weight of a solvent, such as N-methylpyrrolidone (NMP). An anode composition used in the present invention may include 100 parts by weight of an anode active material, such as carbon, 10 parts or less by weight of a conducting agent, such as carbon black, 2-10 parts b weight of a binder, such as PVDF, and 30-100 parts by weight of a solvent, such as N-NMP.

Any separator that is commonly used in lithium ion batteries can be used in the present invention. A porous membrane made of a polymeric material such as polyethylene or polypropylene can be used for the separator. The container used in the present invention may be made of a thermoplastic material that does not react with the components of the battery, preferably, a material that can be thermally sealed.

The lithium battery according to the present invention may have a non-limiting shape, for example, an angular shape, a cylindrical shape, etc.

The lithium battery according to the present invention can be a lithium primary battery or a lithium secondary battery.

The present invention will be described in greater detail with reference to the following examples. The following examples are for illustrative purposes and are not intended to limit the scope of the invention.

### EXAMPLES 1 THROUGH 8 & COMPARATIVE EXAMPLES 1 THROUGH 7:

Preparation of Electrolyte Precursor Solutions

2 g of poly(2-vinylpyridine-co-styrene) (PVPS, available from Aldrich), 0.5 g of 1,4-butandiol diglycidylether (BDDGE, available from Aldrich), and cyclohexylbenzene (CHB, available from Aldrich)) serving as an additive that can enhance stability in the case of overcharging were dissolved in a 1M LiPF₆-containing solvent mixture of EC, DEC, and PC to prepare an electrolyte precursor solution. The concentrations of the PVPS, BDDGE, and lithium salt were constant whereas the amounts of propane sultone (PS), vinylene carbonate (VC) and/or cycloehexylbenzene (CHB) in each electrolyte solution were varied as in Table 1.

<Manufacture of Lithium Batteries>

Initially, a cathode composition was prepared by mixing 100 parts by weight of LiCoO₂, 3 parts by weight of binder PVDF, and 3 parts by weight of conducting agent carbon black for improving mobility of electrons. 90 parts by weight of N-methylpyrrolidone (NMP) and ceramic balls were added to the mixture and mixed in a 200-mL plastic bottle for 10 hours. The cathode composition was cast onto a 15-μm-thick aluminum foil using a 250-μm-doctor blade and dried in an oven at about 110° C. for about 12 hours until the NMP was fully vaporized. The resultant structure was roll-pressed and cut to a predetermined size to obtain a cathode plate having a thickness of 95 μm.

An anode composition was prepared by mixing 100 parts by weight of carbon (natural carbon), 3 parts by weight of conducting agent carbon black, and 3 parts by weight of polyvinylidene fluoride. 90 parts by weight of N-NMP and ceramic balls were added to the mixture and mixed for about 10 hours. The anode composition was cast onto a 12-μm-thick copper foil using a 300-μm-doctor blade and dried in an oven at about 90° C. for about 10 hours. The resultant structure was roll-pressed and cut to a predetermined size to obtain an anode plate having a thickness of 120 μm.

A polyethylene/polypropylene porous membrane (Asahi Co., Japan) having a thickness of 20 μm was used as a separator.

The cathode plate and the anode plate with the porous membrane therebetween were rolled to manufacture a battery assembly. This jelly-roll type battery assembly was placed in an aluminum-laminated battery container, and each of the electrolyte compositions prepared in Examples 1 through 8 and Comparative Examples 1 through 7 was injected into the case to obtain a complete, 900 mAh-grade lithium secondary battery.

The capacity, high-rate characteristic, stability at high temperature, and processibility were measured using the batteries. The results are shown in Table 1.

TABLE 1

| | | | | High-rate | | |
|---|---|---|---|---|---|---|
| | | | Capac- | character- | Stability at high | |
| | Com- | Amount | ity | istic | temperature | |
| Example | pound | (weight %) | (mAh) | (2C) | (150° C./10 min) | Processibility |
| Comparative | PS | 0.00 | 928.5 | 96.1 | Failed | Good |
| Example 1 | | | | | | |
| Comparative | PS | 0.25 | 930.8 | 96.4 | Failed | Good |
| Example 2 | | | | | | |
| Comparative | PS | 0.50 | 926.9 | 96.8 | Failed | Good |
| Example 3 | | | | | | |
| Comparative | PS | 0.75 | 931.0 | 96.1 | Passed/Failed | Good |
| Example 4 | | | | | | |
| Comparative | PS | 1.00 | 926.2 | 96.8 | Passed | Poor |
| Example 5 | | | | | | |
| Comparative | PS | 1.50 | 912.6 | 96.0 | Passed | Poor |
| Example 6 | | | | | | |
| Comparative | PS | 2.0 | 890.3 | 91.2 | Passed | Good |
| Example 7 | | | | | | |
| Example 1 | PS/VC | 0.5/1.0 | 931.6 | 96.2 | Failed | Good |
| Example 2 | PS/VC | 0.5/1.5 | 932.8 | 95.5 | Passed | Good |
| Exam le 3 | PS/VC | 0.5/2.0 | 932.5 | 96.8 | Passed | Good |
| Example 4 | PS/CHB | 0.5/1.0 | 929.8 | 97.2 | Passed | Good |
| Example 5 | PS/CHB | 0.5/2.0 | 929.1 | 97.5 | Passed | Good |
| Example 6 | PS/CHB | 0.5/3.0 | 926.6 | 97.5 | Passed | Good |
| Example 7 | PS/CHB | 0.5/4.0 | 925.6 | 97.3 | Passed | Good |
| Example 8 | PS/VC/ | 0.5/1.0/2.0 | 926.3 | 96.5 | Passed | Good |
| | CHB | | | | | |

As is apparent from the results in Table 1, when 1.0% by weight of propane sultone is used, problems arise in the manufacturing processes of batteries although satisfactory safety when operated at high temperature is ensured. However, by reducing the amount of propane sultone and adding vinylene carbonate and/or cyclohexylbenzene as auxiliary additives, satisfactory processibility and safety when operated at high temperature can be ensured.

As described above, in an electrolyte composition and a lithium battery according to the present invention, propane sultone is used as an additive to ensure safety when operated at high temperature and vinylene carbonate and/or cyclohexylbenzene are used as auxiliary additives to ensure safety when operated at high temperature without battery performance degradation.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An electrolyte composition comprising:
a lithium salt; and
an organic solvent containing a nitrogen-containing compound, propane sultone, and vinylene carbonate and/or cyclohexylbenzene.

2. The electrolyte composition of claim 1, wherein the amount of the nitrogen-containing compound ranges from 0.1 to 5% by weight, the amount of the propane sultone ranges from 0.05 to 2% by weight, and the amount of the vinylene carbonate and/or cyclohexylbenzene ranges from 0.25 to 6% by weight, based on the total weight of the electrolyte composition.

3. The electrolyte composition of claim 2, wherein the amount of the vinylene carbonate ranges from 0.25 to 3% by weight based on the total weight of the electrolyte composition.

4. The electrolyte composition of claim 1, wherein the nitrogen-containing compound is selected from among a primary amine, a secondary amine, a tertiary amine, and a polymer, a copolymer, and an oligomer of these amines.

5. The electrolyte composition of claim 4, wherein the primary amine, the secondary amine, and the tertiary amine are at least one compound selected from the group consisting of a 6-member aromatic heterocyclic compound, a 5-member fused aromatic heterocyclic compound, and an aromatic or non-aromatic secondary or tertiary amine.

6. The electrolyte composition of claim 4, wherein the primary amine, the secondary amine, and the tertiary amine are at least one compound selected from the group consisting of pyridine, pyridazine, pyrimidine, pyrazine, triazine, triazole, thiazole, thiadiazole, a compound containing at least one nitrogen atom and at least five carbon atoms.

7. The electrolyte composition of claim 1 further comprising an epoxy-containing compound.

8. The electrolyte composition of claim 7, wherein the amount of the epoxy-containing compound ranges from 0.02 to 1.5% by weight based on the total weight of the electrolyte composition.

9. The electrolyte composition of claim 1, wherein the lithium salt is selected from the group consisting of LiPF₆, LiAsF₆, LiClO₄, LiN(CF₃SO₂)₂, LiBF₄, LiCF₃SO₃, and LiSbF₆, and the concentration of the lithium salt in the organic solvent ranges from 0.5M to 2.0M.

10. A method of manufacturing a lithium battery, the method comprising:
injecting the electrolyte composition of claim 1 into a battery container in which an anode, a cathode, and a separator are contained; and
sealing the battery container.

11. The method of claim 10 further comprising heating the container at a temperature of 30-130° C. after the sealing to gelate the electrolyte composition.

12. A lithium battery manufactured according to the method of claim 10.

13. The lithium battery of claim 12 comprising a gel polymer electrolyte between the anode and the cathode, the gel polymer electrolyte being obtained by gelating the electrolyte composition.

14. A lithium battery containing the electrolyte composition of claim 1.
